(19) United States
(12) Patent Application Publication
(10) Pub. No.: US 2026/0195596 A1
(43) Pub. Date: Jul. 9, 2026

(54) Unified Artificial Intelligence Model with Single Encoder-Decoder Architecture for Domain-Specific Applications

(71) Applicant: Oracle International Corporation, Redwood Shores, CA (US)

(72) Inventors: Nistha Mitra, Seattle, WA (US); Meizhu Liu, Livingston, NJ (US); Daniel Bruce Carter, Redmond, WA (US); Adam Kenneth Ledyard, Seattle, WA (US); Amin Abdaoui, Toulouse (FR)

(73) Assignee: Oracle International Corporation, Redwood Shores, CA (US)

(21) Appl. No.: 19/191,893

(22) Filed: Apr. 28, 2025

Related U.S. Application Data
(60) Provisional application No. 63/742,932, filed on Jan. 8, 2025.

(51) Int. Cl. G06N 3/084; G06N 3/0455; G06N 3/048; G10L 25/30

(52) U.S. Cl. CPC G06N 3/084; G06N 3/0455; G06N 3/048; G10L 25/30

(57) ABSTRACT

An artificial intelligence model having an audio encoder and a language model decoder is trained through unified cross-modal processing. Audio data and corresponding ground truth outputs are received as inputs. The audio encoder generates encoded audio features from the audio data. An adaptation layer projects the encoded audio features to generate projected features aligned with an embedding space of the language model decoder. The language model decoder processes the projected features to generate model outputs. Training combines an alignment loss between projected features and expected decoder input embeddings with an output loss between model outputs and ground truth outputs. The combined losses form a total loss for updating model parameters. Direct fusion between audio encoding and language model processing is enabled without requiring separate automated speech recognition and large language model components, reducing computational overhead while maintaining accuracy in processing audio inputs.

### INCORPORATION BY REFERENCE; DISCLAIMER

Each of the following applications are hereby incorporated by reference: Application No. 63/742,932 filed on Jan. 8, 2025. The applicant hereby rescinds any disclaimer of claims scope in the parent application(s) or the prosecution history thereof and advises the USPTO that the claims in the application may be broader than any claim in the parent application(s).

### TECHNICAL FIELD

This disclosure relates generally to artificial intelligence. More particularly, this disclosure relates to an artificial intelligence model for a domain-specific application such as, for example, a healthcare application.

### BACKGROUND

Electronic Health Records (EHRs) increasingly incorporate audio data, termed “voice EHRs.” These audio recordings include valuable health biomarkers beyond the information in traditional text-based records. Voice EHRs capture respiratory patterns, vocal tone, speech patterns, and linguistic nuances. These features can indicate respiratory health, emotional state, and cognitive function. However, current text-based analytical models cannot fully extract this information. This limitation leads to a loss of potentially crucial diagnostic and therapeutic data. New methods are needed to analyze and utilize the complex data present in voice EHRs.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

One or more embodiments of the present disclosure are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system and method for training a unified neural network model with a single encoder-decoder architecture for a domain-specific application according to one or more embodiments;

FIG. 2 illustrates computing alignment loss by combining L1 loss and cosine similarity loss between projected features and expected decoder input embeddings according to one or more embodiments;

FIG. 3 illustrates using a weighting parameter to combine alignment loss and output loss when generating total loss according to one or more embodiments;

FIG. 4 illustrates an adaptation layer comprising two fully connected linear layers, a ReLU activation layer, and a layer normalization layer for projecting encoded features according to one or more embodiments;

FIG. 5 illustrates computing output loss as cross-entropy loss between probability distributions of model outputs and ground truth outputs according to one or more embodiments;

FIG. 6 illustrates updating adaptation layer parameters while maintaining fixed parameters for the audio encoder and language model decoder according to one or more embodiments;

FIG. 7 illustrates storing projected features in a vector database and retrieving relevant features based on similarity between query embeddings and stored features according to one or more embodiments;

FIG. 8 is a flowchart of a method for training a unified neural network model with a single encoder-decoder architecture for a domain-specific application according to one or more embodiments;

FIG. 9 illustrates an example transformer architecture that may be used in the implementation of an LLM according to one or more embodiments; and

FIG. 10 illustrates an example computer system for use in implementing a unified neural network model with a single encoder-decoder architecture for a domain-specific application according to one or more embodiments.

### DETAILED DESCRIPTION

In the following detailed description, for the purposes of explanation, numerous specific details are set forth to aid understanding of one or more embodiments of the present disclosure. In some instances, an embodiment of the present disclosure may be practiced without one or more of these specific details. In some cases, a described feature of one embodiment of the present disclosure is also a feature of one or more other embodiments of the present disclosure even though the feature is not expressly described with respect to one or more other embodiments. In some embodiments, well-known structures and devices are shown in the figures in block diagram form to avoid unnecessarily obscuring the embodiment.
1. GENERAL OVERVIEW
2. CURRENT HEALTHCARE ARTIFICIAL INTELLIGENCE APPROACHES
3. UNIFIED TRANSFORMER MODEL WITH SINGLE ENCODER-DECODER ARCHITECTURE FOR DOMAIN-SPECIFIC APPLICATIONS
   3.1 ALIGNMENT LOSS
   3.2 WEIGHTING PARAMETER
   3.3 ADAPTATION LAYER
   3.4 OUTPUT LOSS
   3.5 TARGETED TRAINING
   3.6 RAG IMPLEMENTATION
4. METHOD FOR TRAINING A UNIFIED NEURAL NETWORK MODEL WITH A SINGLE ENCODER-DECODER ARCHITECTURE FOR A DOMAIN-SPECIFIC APPLICATION
5. EXAMPLE EMBODIMENT
6. PRACTICAL APPLICATIONS; ADVANTAGES; IMPROVEMENTS
7. EXAMPLE LLM ARCHITECTURE
8. COMPUTER NETWORKS AND CLOUD NETWORKS
9. HARDWARE OVERVIEW
10. MISCELLANEOUS; EXTENSIONS
1. General Overview

In one embodiment, a computer-implemented method trains a model incorporating both an audio encoder and a language model decoder. The method begins by accepting input audio data paired with corresponding ground truth outputs. The audio encoder component processes the received audio data to generate encoded audio features. These encoded audio features undergo projection through the model, producing projected features that align with the embedding space utilized by the language model decoder. The model then processes the projected features to generate model outputs. Two distinct loss calculations are performed: an alignment loss measuring the difference between projected features and expected decoder input embeddings, and an output loss comparing the model outputs against the corresponding ground truth outputs. The method combines these individual losses to compute a total loss value. The final step involves updating the model parameters based on the calculated total loss. In one embodiment, this training approach enables joint optimization of the audio encoding and language decoding components while maintaining alignment between the encoded audio representations and the decoder's expected input space.

In one or more embodiments, a unified encoder-decoder architecture combines audio encoding capabilities with large language model (LLM) processing to enhance medical conversation transcription accuracy. The architecture implements a direct fusion between an audio encoder and language model through a specialized adaptation layer, enabling single-pass processing rather than sequential Automated Speech Recognition (ASR)-then-LLM approaches.

In one or more embodiments, the adaptation layer serves as a bridge component, performing dimensionality reduction and feature projection to map audio encoder outputs into the LLM embedding space. The adaptation layer subsamples high-dimensional acoustic features while maintaining temporal and spectral characteristics. Cross-modal attention mechanisms within the adaptation layer create explicit alignments between acoustic and linguistic or output representations, generating a unified embedding space.

In one or more embodiments, a training methodology preserves computational efficiency by freezing both the audio encoder and the LLM components. The adaptation layer undergoes training in the base configuration though full model fine-tuning remains available for domain-specific optimization. In one example implementation, the approach achieves a 26% reduction in word error rate (WER) compared to current medical transcription systems while maintaining faster inference speeds than sequential architectures.

In one or more embodiments, the cross-modal attention mechanism employs L1 loss to enforce alignment between audio and output embedding vectors in both magnitude and directional components. This alignment strategy enables the model to capture relationships between acoustic patterns and output elements, supporting applications beyond basic transcription. The direct processing of audio features allows extension to various healthcare scenarios, including medical dialogue analysis and diagnostic device signal processing.

In one or more embodiments, the unified architecture distinguishes itself from single-modality models through explicit cross-modal mapping capabilities. While single-modality models can be performant at transcription within the audio domain, one or more embodiments create direct bridges between acoustic and output representations. The adaptation mechanism eliminates the need for separate audio encoder training while enabling fine-grained feature mapping between modalities.

One or more embodiments demonstrate particular effectiveness in medical contexts where precise transcription of domain-specific terminology and acoustic patterns proves useful. The architecture supports deployment across multiple healthcare applications, from consultation recording to voice-based diagnostic systems, while maintaining computational efficiency through selective training of the adaptation layer.

One or more embodiments described in this Specification and/or recited in the claims may not be included in the General Overview section.

### 2. Current Healthcare Artificial Intelligence (AI) APPROACHES

Current medical transcription systems face significant limitations due to underutilized audio biomarkers and fragmented AI architectures. Traditional text-based models neglect valuable diagnostic information embedded within audio data streams, reducing diagnostic accuracy and completeness. The separation between transcription models and diagnostic systems creates technological barriers that prevent comprehensive data utilization.

Current medical transcription approaches typically combine ASR with LLMs in sequential processing chains. The sequential architecture demands substantial computational resources for operating multiple models simultaneously. Real-time applications suffer from increased latency due to post-processing requirements between ASR output generation and LLM refinement stages. System scalability becomes restricted by resource demands across multiple model components.

The fragmented nature of dual-model implementations introduces additional technical constraints. Data is required to traverse multiple processing stages between distinct models, creating potential failure points throughout the processing pipeline. The separation between transcription and semantic refinement stages reduces overall system efficiency. These architectural limitations impede rapid deployment of ASR-LLM solutions within healthcare environments.

The absence of unified modeling approaches prevents effective capture and integration of diverse audio features. Current systems lack mechanisms for combining acoustic biomarkers with linguistic analysis in a single computational framework. This architectural gap limits the potential for AI systems to extract maximum value from available healthcare data streams.

Processing inefficiencies in current implementations slow the advancement of real-time medical documentation capabilities. The computational overhead of managing separate models restricts deployment options in resource-constrained healthcare settings. These technical barriers prevent healthcare providers from fully leveraging automated transcription technologies for improved patient care delivery.

The limitations of existing approaches highlight the need for integrated architectures that combine ASR and LLM capabilities. A unified system could reduce computational requirements while enabling more efficient processing of medical audio data. Such architectural improvements would support faster deployment and broader adoption of automated transcription technologies across healthcare applications.

### 3. Unified Transformer With Single Encoder-Decoder Architecture for Domain-Specific Applications

In one or more embodiments, the unified AI architecture combines audio and text processing through an integrated encoder-decoder transformer design. The unified model processes multiple audio biomarkers, including voice tonality, breathing patterns, and speech characteristics, while simultaneously analyzing textual content. The multimodal fusion generates comprehensive representations capturing clinical intentions, emotional states, and medical condition indicators.

In one or more embodiments, a lightweight encoder-decoder transformer forms the architectural foundation. The encoder component extracts health-relevant features from speech signals. The decoder-based language model processes these features alongside textual information. The unified structure eliminates requirements for separate transcription, documentation, and diagnostic systems, reducing workflow complexity.

In one or more embodiments, the integrated architecture addresses computational inefficiencies through combined audio-text processing. By merging the audio encoder and language model components, the integrated architecture reduces overall processing requirements compared to traditional sequential approaches. The streamlined design enables real-time operation by removing post-processing steps between ASR and language model stages.

In one or more embodiments, resource optimization enables improved scalability characteristics. The consolidated model architecture requires fewer computational resources for managing transcription and semantic analysis tasks. Direct audio-to-text processing eliminates data transfer operations between independent systems, reducing potential failure points in the processing pipeline.

In one or more embodiments, prompt engineering provides flexible adaptation capabilities without model retraining requirements. Healthcare practitioners can customize output formats for specific clinical applications, from patient history summarization to detailed diagnostic reporting. The architecture supports audio-based, retrieval-augmented generation (RAG), enabling real-time information retrieval and processing during clinical interactions.

In one or more embodiments, the unified approach maximizes information extraction from multimodal inputs while simplifying operational workflows. Direct processing of combined audio-text data streams reduces system complexity. Real-time processing capabilities support immediate clinical decision-making applications. The architecture provides an integrated solution for modern healthcare environments requiring efficient multimodal analysis.

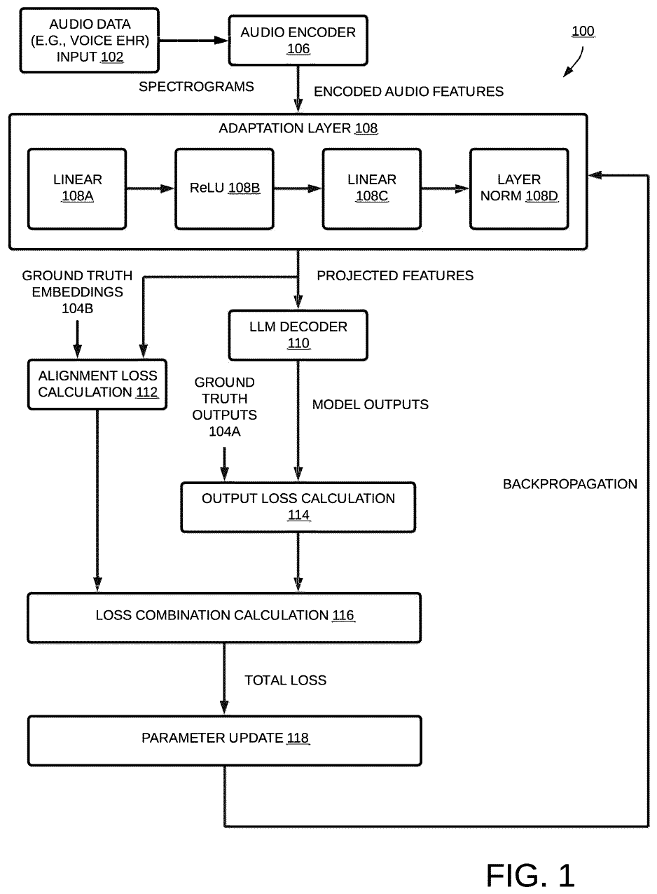

FIG. 1 illustrates a system and a method for training a unified transformer model 100 with a single encoder-decoder architecture for a domain-specific application in accordance with one or more embodiments. The unified model 100 includes an adaptation layer 108 that unifies an audio encoder 106 and LLM decoder 110.

Starting from the top of FIG. 1, audio data input 102 represents the initial data ingestion component of the audio-to-output model. The data ingestion component accepts raw audio input data sampled, for example, at 16,000 kHz or other sampling rate compatible with the audio encoder 106. Raw audio input data originally sampled at a higher rate, like 44.1 kHz or 48 kHz, is down sampled to 16,000 kHz or other suitable sample rate before processing by the audio encoder 106. The audio input encompasses speech and/or non-speech sounds, including medical-specific audio, such as coughs, breathing patterns, and heart sounds.

Audio data input 102 represents an entry point for training data. In one implementation, the training data includes approximately 1 million audio data points (e.g., audio files) of medical-specific content. The training data includes actors reading prescriptions, simulated doctor-patient conversations, medical diagnostic sounds, and/or actual doctor-patient conversations that have been de-identified to preserve privacy (e.g., for HIPPA compliance). Medical diagnostic sounds captured in audio data (e.g., training data) include heart sounds, lung sounds, bowel sounds, joint sounds, and/or vascular sounds. Heart sounds include S1 and S2 (normal heart sounds), murmurs, gallops, and rubs. Lung sounds include bronchial breath sounds, vesicular breath sounds, crackles (rales), wheezes (rhonchi), and pleural friction rubs. Bowel sounds encompass normal peristaltic activity, hyperactive bowel sounds, hypoactive bowel sounds, and borborygmi. Joint sounds include crepitus from bone-on-bone contact or snapping of tendons. Vascular sounds include carotid bruits and venous hums. Audio data may include sounds from medical devices, like blood pressure readings or dialysis machines. These diagnostic sounds range in frequency from very low (few Hz) for some heart sounds to relatively high (several kHz) for some lung sounds. Medical professionals use these sounds to diagnose conditions, monitor treatment progress, and assess patient health status. The audio encoder 106 processes these varied diagnostic sounds through spectral analysis to identify clinically relevant acoustic features.

In one or more embodiments, voice-based electronic health records (EHRs) provide another source of audio data input 102. Medical professionals dictate clinical notes, patient histories, physical examination findings, treatment plans, and discharge summaries through voice recording systems. The voice-based EHR data includes structured documentation elements like chief complaints, review of systems, physical examination findings, assessment notes, and treatment plans. Audio data from voice-based EHRs contains specialized medical terminology, anatomical references, pharmaceutical names, diagnostic codes, and procedural descriptions. The audio encoder 106 processes spoken medical terminology to maintain semantic accuracy during subsequent language model decoding. Natural speech patterns in voice-based EHRs exhibit varying prosodic features, speaking rates, and acoustic characteristics across different healthcare providers. Acoustic analysis of voice-based EHR content enables extraction of clinically relevant speech features while preserving the structured nature of medical documentation. The combination of diagnostic sounds and voice-based EHR content provides comprehensive training data for the unified encoder-decoder architecture. In an embodiment, voice EHRs are de-identified for privacy and regulatory compliance (e.g., HIPPA compliance).

In an embodiment, voice-based EHR data undergoes de-identification processing to remove protected health information (e.g., for compliance with HIPAA regulations) before being a source of audio data input 102. De-identification methods include removal of patient names, medical record numbers, dates of birth, addresses, phone numbers, and other personally identifying information or otherwise sensitive information from the audio stream. Advanced audio processing techniques mask or remove segments containing protected information while preserving surrounding clinical content.

The audio data input 102 computes spectrograms (e.g., log-mel spectrograms) over audio segments. For example, a spectrogram for a 30 second audio segment may be computed using a window size of 25 milliseconds, a stride (hop length) of 10 milliseconds, and 80 mel frequency bins resulting in a log-mel spectrogram with approximately 3,000 time frames and 80 frequency channels. Audio data input 102 interfaces with the audio encoder 106, providing properly formatted audio input (e.g., formatted as log-mel spectrograms) for feature extraction.

In one implementation, audio segments are limited to approximately 30 seconds in length with automatic segmentation implemented for longer recordings. However, the processing of audio segments accommodates variable-length inputs through the design of the encoder 106 architecture. The 30-second segment length represents an implementation choice of one or more embodiments that balances computational efficiency with context capture.

Audio segments from 5 seconds to 60 seconds are processable by the encoder 106 due to the transformer architecture's ability to handle variable-length sequences. The mel spectrogram computation applies across various segment lengths. Longer audio segments provide additional temporal context for the model but require more memory and computation. Shorter segments reduce memory requirements while potentially sacrificing some contextual information. The number of output embeddings scales linearly with the input segment length, maintaining the 2:1 ratio between input frames and output embeddings due to initial convolutional down sampling. For example, a 15-second segment produces approximately 750 embedding vectors, while a 45-second segment produces approximately 2250 embedding vectors. The adaptation layer 108 is capable of processing various number of embedding vectors since the transformer decoder architecture accepts variable-length inputs.

The window size for computing the log-mel spectrogram ranges from 10 ms to 50 ms, with 25 ms serving as the window size in one implementation. Window sizes affect the time-frequency resolution tradeoff in the spectral analysis. Shorter windows provide better temporal resolution while longer windows improve frequency resolution. The hop length between successive varies from 5 ms to 20 ms with 10 ms being used in an implementation. Smaller hop lengths create more overlap between windows, producing smoother spectral transitions at the cost of increased computational overhead. The number of mel frequency bins ranges from 40 to 128 bins. Higher bin counts preserve more spectral detail but increase the dimensionality of the feature representations. The mel scale spacing of frequency bins approximates human auditory perception by providing finer resolution at lower frequencies. These parameters interact to determine the temporal and spectral granularity of the audio features processed by the encoder. A window size of 25 ms with 10 ms hop length and 80 mel bins represents one effective combination for speech and sound recognition tasks. However, the parameters can be adjusted based on specific requirements for temporal precision, frequency resolution, and computational constraints.

The audio encoder 106 represents a neural network component that processes raw audio input data to generate encoded audio features. The audio encoder architecture implements a multi-layer transformer model that processes time-frequency representations of input audio. The first stage applies a convolutional neural network to down sample the temporal dimension of log-mel spectrograms by a factor of two. A linear projection layer maps the processed spectrograms to an embedding dimension suitable for transformer processing. The transformer encoder comprises multiple identical blocks stacked sequentially. A transformer block includes a multi-head self-attention layer followed by a feed-forward neural network. The self-attention mechanism enables modeling of long-range dependencies across the temporal sequence. Layer normalization precedes both the self-attention and feed-forward components in a pre-norm configuration. Residual connections around both components facilitate gradient flow during training. The feed-forward network in a block includes two linear transformations with a ReLU activation function between them. The entire encoder produces a sequence of embeddings that capture acoustic-phonetic features from the input audio. The number of transformer blocks, embedding dimension size, number of attention heads, and feed-forward network dimensions are adjustable to create models of varying capacity. The encoder architecture maintains causality by applying appropriate attention masks, enabling real-time processing applications. Skip connections between layers promote information flow and aid optimization. Dropout may be applied to attention weights and feed-forward activations to prevent overfitting.

Variations to the audio encoder 106 are possible, including modifying the convolutional front-end by adjusting stride lengths, kernel sizes, or adding additional convolutional layers. The down sampling factor can be changed from two to other values through alternative stride configurations. Multiple parallel convolutional pathways with different filter sizes enable multi-scale feature extraction. The transformer blocks can incorporate alternative attention mechanisms, such as linear attention, local attention patterns, or hierarchical attention structures. The feed-forward networks within transformer blocks may implement different activation functions like GELU instead of ReLU. Layer normalization positioning can shift to a post-norm arrangement or be replaced with alternative normalization schemes such as instance normalization. The embedding dimension can scale from smaller sizes, like 384, to larger sizes, like 1536, depending on model capacity requirements. The number of transformer layers can range from 6 to 32 layers based on computational constraints and performance goals. Attention head counts in multi-head attention layers may vary from 6 to 20 heads. The feed-forward network dimension typically ranges from 4 to 8 times the embedding dimension. Residual connections can include scaling factors or gating mechanisms. Position encodings may use learned embeddings instead of fixed sinusoidal encodings. The architecture can incorporate auxiliary tasks through additional prediction heads branching from intermediate layers. Squeeze-and-excitation blocks, or similar channel attention mechanisms, can augment the standard self-attention. The encoder can process overlapping segments of input features to maintain temporal continuity. Progressive down sampling across multiple transformer layers provides an alternative to early convolutional down sampling.

In an implementation, the audio encoder 106 generates approximately 1,500 embeddings for a 30-second log-mel spectrogram. A generated embedding has a dimensionality ranging from 384 to 1,536 dimensions, depending on the size of the audio encoder model. As an example, for a 30-second log-mel spectrogram, there are 3,000 time frames with a 10 ms stride. The audio encoder 106 includes strided convolutions at the start that effectively down sample the time dimension by a factor of 2. Consequently, 3,000 time frames results in approximately 1,500 embedding vectors.

The ground truth output 104A represents a data input component in the training architecture that provides the target or reference outputs against which the LLM decoder 110's performance is evaluated. Ground truth output 104A includes the correct transcriptions and/or expected outputs corresponding to the input audio data. In the context of medical speech recognition, these ground truth outputs 104A include accurate transcriptions of medical terminology, prescriptions, and doctor-patient conversations.

For medical diagnostic audio input, the ground truth 104A includes one or more types of clinically relevant annotations. A first type comprises diagnostic labels indicating specific medical conditions identified through auscultation, such as aortic stenosis, mitral regurgitation, pneumonia, or bowel obstruction. A second type includes quantitative measurements synchronized with the audio, such as heart rate values, respiratory rate counts, or blood pressure readings. A third type encompasses temporal annotations marking the precise timing of significant acoustic events, like S1 and S2 heart sounds, the onset of wheezing, or changes in bowel motility patterns. A fourth type includes severity scores assigned by medical professionals to grade the intensity of abnormal sounds, like cardiac murmurs or lung crackles. A fifth type includes structured classifications of sound characteristics, such as timing (systolic/diastolic), pitch (high/medium/low), and quality (harsh/musical/scratchy).

For medical diagnostic audio input, the decoder 110 is configured (e.g., trained) to produce specific types of outputs that correspond to the medical diagnostic ground truth output 104A annotations. The decoder 110 generates diagnostic labels through classification heads trained to identify conditions, such as aortic stenosis and pneumonia, from the encoded audio features. Separate regression heads in the decoder 110 output continuous numerical values, such as heart rate measurements and respiratory rate counts, aligned with the audio timeline. The decoder 110 implements temporal localization mechanisms to mark significant acoustic events by predicting start and end timestamps within the audio segment. Severity scoring occurs through ordinal classification heads that output standardized grades matching expert-assigned intensity levels for murmurs and other abnormal sounds. Sound characteristic prediction requires multi-label classification outputs covering timing, pitch, quality, and other acoustic properties defined in clinical guidelines. The decoder 110 architecture supports both single-task and multi-task configurations to simultaneously generate multiple types of clinically relevant outputs. Output embedding dimensions and layer configurations vary based on the complexity and number of prediction tasks. The loss computation 114 components compare the decoder 110's diagnostic labels, measurements, timestamps, severity scores, and sound classifications against the corresponding ground truth output 104A annotations. Training optimizes the decoder 110 to match human expert assessments across various types of medical diagnostic audio.

The ground truth outputs 104A and the ground truth embeddings 104B serve at least two functions in the training process. First, they provide reference data for calculating the output loss 114 by comparing the model 110's generated outputs against known expected output. Second, they establish the expected decoder 110 input embeddings 104B used in calculating the alignment loss 112. The ground truths 104A and 104B interface directly with the loss calculation components 112 and 114, respectively.

The ground truth outputs 104A comprise multiple types of expected outputs depending on the application domain of the model. For speech input audio data, the ground truth outputs 104A include reference transcriptions containing the exact text corresponding to spoken words in the input audio. These transcriptions serve as target outputs for training the decoder 110 to accurately convert speech to text. For medical diagnostic applications, the ground truth outputs 104A encompass expected diagnostic classifications or assessments derived from audio medical data. The medical audio inputs may include heart sounds, lung sounds, or other physiological audio signals. The corresponding ground truth outputs 104A include expert-labeled diagnostic information, such as presence/absence of cardiac conditions, respiratory conditions, or other medical states detectable through audio analysis.

The model 100 compares generated outputs against ground truth outputs 104A during training to calculate the output loss 114. The output loss quantifies how closely the decoder 110's predictions match the expected transcriptions or diagnostic outputs. The model 100 also compares projected features generated by the adaptation layer 108 from the encoded audio features against ground truth embeddings 104B during training to calculate the alignment loss 112. By minimizing both alignment loss and output loss, the training method optimizes the model 100 to generate accurate text transcriptions and/or medical diagnostic outputs from the respective types of input audio data. The dual loss approach helps ensure the projected features output by the adaptation layer 108 maintain semantic alignment with the language model decoder 110's embedding space while simultaneously improving output accuracy. This training strategy enables the model 100 to effectively bridge the gap between audio inputs and text/diagnostic outputs across different application domains.

The adaptation layer 108 represents an architectural component that bridges the dimensional and representational gap between the audio encoder 106 output and language model decoder 110 input spaces. In an implementation, the adaptation layer 108 includes four sequential processing layers designed to transform encoded audio features into a format compatible with the language model decoder 110's embedding space. The adaptation layer 108 implements a transformation pipeline. The first layer is a fully connected linear layer 108A that transforms the acoustic features into a 2048-dimensional hidden space. This dimensionality was determined in one implementation through systematic hyperparameter optimization. A ReLU activation function 108B follows, introducing non-linearity to capture complex patterns in the audio representations. The third component is a second fully connected linear layer 108C. This layer maps the intermediate representations to match the specific dimensional requirements of the language model decoder 110's embedding space. The final layer 108D normalizes the outputs using layer normalization, ensuring training stability and consistent feature scaling.

The adaptation layer 108 processes encoded audio features sequentially. The adaptation layer 108's architecture enables proper “translation” between the audio encoder 106's acoustic feature space and the language model decoder 110's textual embedding space. This translation capability is useful for the model 100's ability to handle both speech and non-speech audio patterns while maintaining medical domain accuracy. The adaptation layer 108's complexity represents a trade-off between model expressiveness and training data requirements. The four-layer structure was determined in one implementation to be optimal for medical conversation complexity though the architecture remains flexible for different applications through hyperparameter tuning.

The adaptation layer 108 architecture can be modified through several structural variations while maintaining the core function of bridging encoder 106 and decoder 110 representation spaces. The number of fully connected linear layers 108A and 108C can be increased beyond two to create deeper transformations, allowing more complex non-linear mappings between acoustic and textual embeddings. Additional linear layers enable hierarchical feature abstraction through progressive dimensionality changes.

The dimensionality of intermediate hidden spaces can be adjusted from 2048 to other values based on specific audio-text alignment requirements. Larger hidden dimensions may capture richer feature representations at the cost of increased computational overhead. Smaller hidden dimensions can reduce model complexity while potentially sacrificing representational capacity.

Alternative activation functions can replace the ReLU 108B non-linearity. GELU activations provide smooth gradients and natural dropout behavior. Swish activations offer self-gating properties that may benefit audio feature transformation. Leaky ReLU or PReLU variants prevent potential dead neuron issues during training.

The layer normalization 108D component can be supplemented or replaced with batch normalization or instance normalization. Batch normalization may improve training dynamics through mini-batch statistics. Instance normalization can help handle varying audio segment lengths. Multiple normalization layers can be inserted between linear transformations to maintain stable gradients in deeper architectures.

Residual connections can be added between layers to facilitate gradient flow and preserve low-level acoustic information. Skip connections allow direct paths from early to later processing stages. Dense connections can create rich feature hierarchies by concatenating outputs from multiple layers.

Attention mechanisms can augment or replace certain linear layers to capture dynamic relationships between audio features. Self-attention layers enable adaptive feature weighting based on contextual patterns. Cross-attention between encoder and adaptation features can guide the transformation process through learned alignments.

The sequential processing structure can incorporate parallel pathways operating at different temporal scales. Multi-branch architectures process features at multiple resolutions before fusion. Hierarchical designs progressively combine local and global audio patterns through staged feature transformation.

The language model decoder 110 represents a processing component that transforms projected audio features into final model outputs. This decoder 110 includes a decoder LLM architecture that processes the aligned feature representations from the adaptation layer. The decoder 110 operates on the projected features that have been transformed to match its embedding space dimensionality. The decoder 110 receives input through a directional connection from the adaptation layer's normalized output. The decoder 110 processes these aligned embeddings using cross-attention mechanisms to generate contextually appropriate textual outputs.

In the training process, the decoder 110 generates output sequences that are compared against ground truth data 104A for loss calculation 114. The decoder 110's embedding space characteristics also inform the alignment loss computation 112, ensuring proper feature projection through the adaptation layer 108. The language model decoder 110 specifically avoids encoder-decoder architectures, instead utilizing decoder models optimized for domain-specific accuracy. The decoder 110's architecture allows for flexible replacement with different decoder models while maintaining the core processing pipeline. The decoder 110's performance directly impacts both the output quality and effectiveness of the alignment loss computation 112 in the training process.

The language model decoder 110 employs a transformer architecture comprising a stack of decoder blocks. A decoder block includes a masked, multi-head, self-attention sublayer followed by a feed-forward neural network sublayer. The masked self-attention mechanism prevents attending to future tokens during sequence generation by masking out rightward positions in the attention matrix.

A multi-head attention sublayer projects input embeddings into query, key, and value representations across multiple attention heads. The attention heads enable capturing different types of dependencies between sequence positions. Scaled dot-product attention computes compatibility scores between queries and keys, which are used to create weighted combinations of values. The multi-head outputs are concatenated and projected through a linear transformation.

The feed-forward sublayer applies two linear transformations with a ReLU activation in between. The first linear layer expands the embedding dimension to a larger intermediate size such as 4× the model dimension. The second linear layer projects back to the original embedding dimension. Layer normalization and residual connections wrap both the self-attention and feed-forward sublayers.

Multiple decoder blocks are stacked sequentially with the output of one block feeding into the next. The depth of the decoder stack affects model capacity and computational requirements. Configurations range from 6 to 24 layers. Position encodings are added to input embeddings to provide sequence order information. The final decoder layer outputs are projected to vocabulary logits for text generation or diagnostic classification.

The transformer decoder architecture enables modeling long-range dependencies through direct attention between any pair of positions. The multi-layer structure builds up increasingly abstract representations useful for mapping projected audio features to target outputs. Tuning of architecture parameters, such as model dimension, number of heads, and layer count, helps balance performance and efficiency for specific audio processing applications.

The alignment loss calculation 112 represents a computational component that measures how well the projected features from the adaptation layer 108 align with the expected decoder 110 input embeddings of the ground truth 104B in the model 100's training process. The alignment loss calculation 112 implements a dual-metric approach combining L1 loss and cosine similarity calculations between vector representations. The alignment loss calculation 112 receives two inputs, the projected features output from the adaptation layer 108 and the expected embeddings 104B that the language model decoder 110 is designed to process.

The alignment loss 112 performs vector-based calculations to quantify the dimensional and directional alignment between these two embedding spaces. An L1 loss component measures absolute differences between corresponding vector elements. A cosine similarity component evaluates the angular difference between the vectors in the high-dimensional space. These calculations produce a scalar alignment loss value that indicates how effectively the adaptation layer 108 is transforming the audio encoder 106's output into a format compatible with the decoder 110's input requirements.

The alignment loss calculation 112 serves as one of two training signals. This loss specifically targets the adaptation layer 108's performance in bridging the semantic gap between audio and language representations. The alignment loss calculation 112 outputs a loss value that flows into the loss combination calculation 116 for integration with the output loss calculation 114. The loss combination calculation 116 distinguishes the model 100 from existing sequential ASR-LLM pipeline approaches by directly optimizing the interface between modalities.

The output loss calculation 114 represents a computational component in the model 100 training process that evaluates the difference between the decoder 110's generated outputs and the expected ground truth outputs 104A. The output loss calculation 114 performs error measurement between the language model decoder 110's predictions and the known correct outputs provided during training.

The output loss calculation 114 receives two inputs, the model outputs from the language model decoder 110 and the corresponding ground truth outputs 104A from the training dataset. For medical transcription applications, these ground truth outputs 104A include accurate medical transcriptions, including proper medication names and medical terminology.

The calculation performed by the output loss calculation 114 generates a scalar loss value quantifying how well the decoder 110's outputs match the expected results. This component implements loss functions suitable for comparing text sequences, such as cross-entropy loss for classification tasks or specialized loss metrics for medical terminology accuracy.

The output loss calculation 114 serves as one half of the dual loss approach. When combined with the alignment loss 112, the output loss calculation 114 helps guide the model 100 toward both accurate transcription/output and proper internal representations. The output loss calculation 114 outputs a single loss value that flows into the loss combination calculation 116 for weighted aggregation with the alignment loss calculation 112.

The loss combination calculation 116 represents a computational component that merges two distinct loss signals-the alignment loss calculation 112 and output loss calculation 114—into a unified total loss metric used for model 100 optimization. The loss combination calculation 116 implements a weighted combination mechanism that balances the contribution of both loss components using a tunable alpha parameter.

The loss combination calculation 116 receives two input signals, the alignment loss 112 measuring the projection quality between audio encoder outputs and decoder input embeddings and the output loss 114 comparing the decoder 110's final outputs against ground truth transcriptions and/or outputs. The combination is performed through a weighted sum operation where the alpha parameter controls the relative importance of a loss component.

The loss combination calculation 116 serves as a junction in the training process. The loss combination 116's output—the total loss—drives the parameter updates across at least the adaptation layer 106 of the model 100. This combined loss approach ensures simultaneous optimization of both feature projection quality and final output accuracy.

An implementation uses loss combination techniques. The loss combination calculation 116 maintains mathematical properties necessary for stable gradient flow during backpropagation. The combined loss signal provides a balanced training objective that improves the adaptation layer 106's projection capabilities. This dual-loss combination represents an innovation in the training methodology. The approach differs from traditional single-loss training by explicitly optimizing the intermediate feature representations.

The parameter update 118 represents a processing component in the model training pipeline that adjusts the adaptation layer 108's parameters based on the calculated total loss. The parameter update 118 component receives the combined loss value that incorporates both the alignment loss 112 and output loss 114 components. The parameter update 118 implements backpropagation through the adaptation layer 106 to optimize the parameters of the adaptation layer 108.

The parameter update 118 components perform gradient-based optimization using the total loss to adjust weights and biases throughout the adaptation layer 108. These updates specifically target the adaptation layer 108, including the fully connected linear layers 108A and 108C, ReLU activation 108B, and layer normalization 108D components. The parameter updates aim to minimize both the alignment loss 112 between projected features and expected embeddings 104B as well as the output loss 114 between model predictions and ground truth 104A.

The update process occurs iteratively during training with an update step moving the parameters of the adaptation layer 108 closer to optimal values for a domain-specific audio processing task. The parameter update 118 component implements hyperparameter-tuned learning rates and optimization algorithms to ensure stable convergence. The parameter updates specifically account for the complex requirements of domain-specific audio processing.

The parameter update 118 represents a later stage in a training iteration, feeding back adjusted parameters to improve the adaptation layer 108's performance on subsequent passes. This component is useful for achieving the disclosed 20% error rate reduction compared to existing solutions while maintaining efficient processing of domain-specific terminology and audio patterns.

### 3.1 Alignment Loss

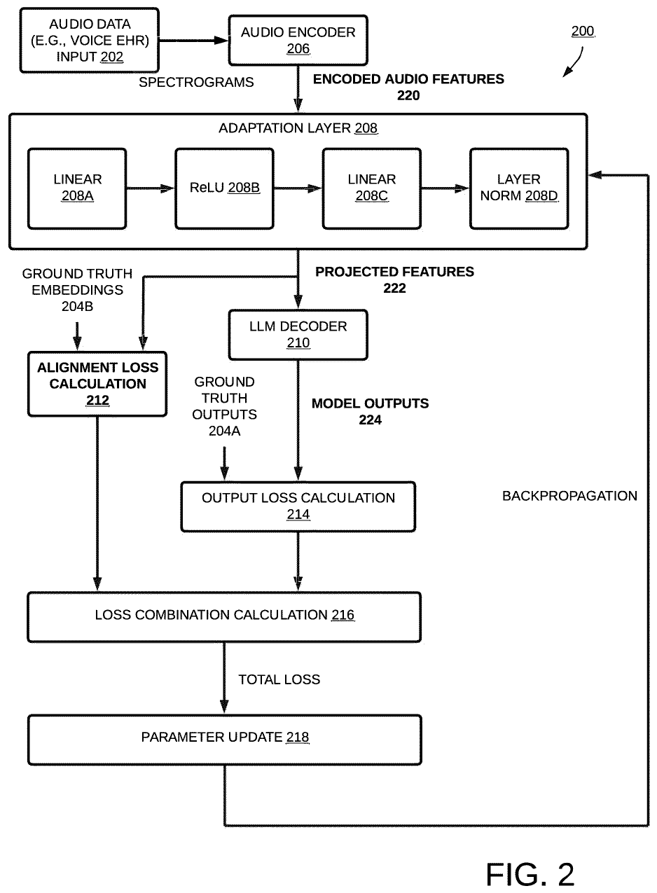

FIG. 2 illustrates computing alignment loss 212 by combining L1 loss and cosine similarity loss between projected features and expected decoder input embeddings according to one or more embodiments of a unified model 200 with a single encoder-decoder architecture for a domain-specific application. Like reference numbers in FIG. 2 refer to corresponding elements described above with respect to FIG. 1. To avoid unnecessarily obscuring an embodiment, description of some elements described above with respect to FIG. 1 is not repeated below.

The encoded audio features 220 represents the output data generated by the audio encoder after processing input audio data. These features are high-dimensional vector representations of acoustic information extracted from the input audio. The encoded features capture frequency patterns, temporal dynamics, and acoustic properties through specialized neural network layers designed for audio processing.

The encoded features 220 maintain a dimensionality that requires transformation, being reduced in one implementation to 2,048 dimensions through the adaptation layer 208's linear transformations. The encoded audio features 220 preserve acoustic information while being structured to enable the adaptation layer 208's alignment function. In one implementation, an encoded audio feature vector represents approximately 20 ms or 25 ms of the audio input. A set of sequential encoded audio features capture the temporal progression of the audio signal.

The projected features 222 serve as transformed representations aligned with the embedding space expected by the language model decoder 210. In one implementation, the adaptation layer 208 generates these features by converting an encoded audio feature vector into a 2,048-dimensional representation compatible with the decoder 210's input requirements. During training of the adaptation layer 208, the projected features 222 undergo evaluation through alignment loss calculations 212 comparing them to expected decoder embeddings 204B using both L1 loss and cosine similarity metrics.

The projected features 222 preserve useful acoustic information while transforming the data into a format enabling accurate processing of domain-specific terminology and non-verbal diagnostic sounds. In an implementation, the 2,048-dimensional size balances complexity and training efficiency. The proper alignment with the decoder 210's embedding space enables unified processing of both speech and non-speech audio inputs.

The model output 224 comprises predicted transcriptions or task-specific results based on processed audio input. The output serves as a component for calculating output loss 214 through comparison against ground truth outputs 204A. The model outputs 224 reflect the effectiveness of both the adaptation layer 208's projection capabilities and the decoder 210's processing of projected features.

The alignment loss calculation 212 implements a dual loss calculation approach. The alignment loss component 212 receives vector representations from the projected features 222 and compares them against expected decoder input embeddings 204B through two operations. The L1 loss calculation measures absolute differences between corresponding vector elements in the projected features 222 and expected embeddings 204B. The cosine similarity loss calculation measures the angular difference between these vectors in high-dimensional space.

The dual loss approach ensures both magnitude and directional alignment between projected audio features 222 and the language model 210's expected input format. The L1 loss maintains precise numeric relationships, while the cosine similarity loss preserves semantic relationships in the embedding space. The combination provides useful training signals for optimizing the adaptation layer 208's projection capabilities.

The implementation of both L1 and cosine similarity losses represents an advancement over traditional single-loss training methods. The dual loss calculation achieves enhanced alignment between audio and language domains while maintaining stable training dynamics. The alignment loss 212 outputs a scalar value that combines with the output loss to guide parameter updates for improving the translation between audio encoder 220 outputs and language model decoder 210 inputs.

### 3.2 Weighting Parameter

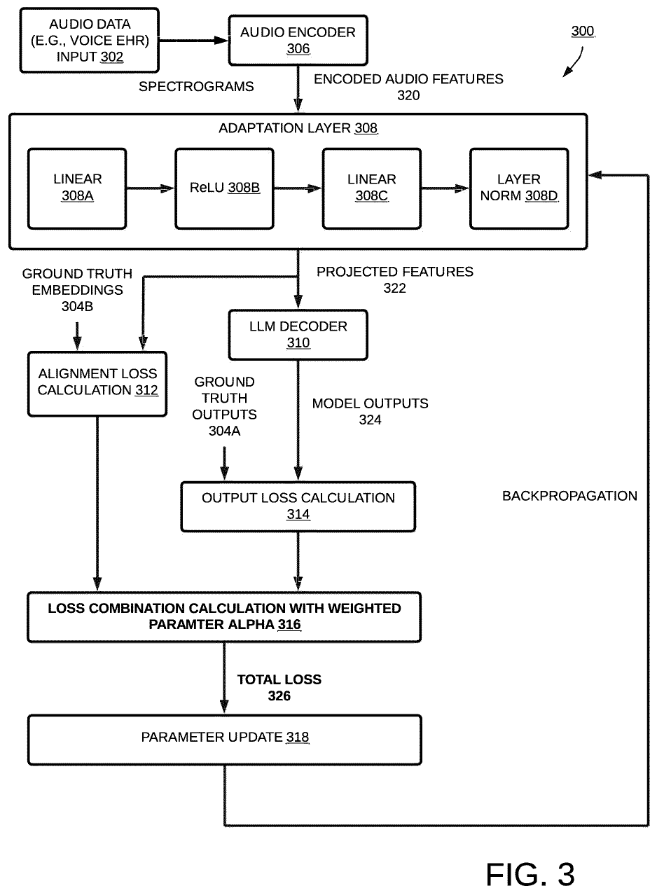

FIG. 3 illustrates using a weighting parameter to combine alignment loss and output loss when generating total loss 326 according to one or more embodiments of a unified model 300 with a single encoder-decoder architecture for a domain-specific application. Like reference numbers in FIG. 3 refer to corresponding elements described above with respect to FIG. 1. To avoid unnecessarily obscuring an embodiment, description of some elements described above with respect to FIG. 1 is not repeated below.

During training, the loss combination 316 combines alignment loss 312 and output loss 314 through a weighting parameter α to produce a total loss 326. The weighting parameter α provides a tunable mechanism for balancing the relative importance of alignment loss 312 versus output loss 314 during training.

The loss combination 316 implements weighted summation by multiplying the alignment loss 312 and output loss 314 components by specific weights determined by α. Grid search methods and cross-validation techniques determine optimal values for the weighting parameter α. Different domain-specific speech recognition applications may require different weightings between feature space alignment and transcription accuracy.

The weighted combination approach enables systematic optimization of the adaptation layer 308's feature mapping capabilities while maintaining high transcription accuracy. Cross-validation procedures validate the selected weighting parameter values across diverse domain-specific audio datasets. Visual validation loss checking guides rapid experimental iteration during α parameter tuning.

The weighted loss combination represents a technical advancement over simple loss addition. The α parameter provides precise control over the training emphasis between intermediate feature alignment and final output accuracy. Experimental results demonstrate a 20% error rate reduction through proper weighting parameter selection.

The weighting parameter α feeds directly into the parameter update 318 component to drive optimization of the adaptation layer 308. In an implementation, this weighted approach achieves improved performance compared to unweighted loss combination while requiring only 300,000 training samples.

In an embodiment, the total loss 326 is computed by the loss combination component 316 as follows during training: total_loss=alpha*alignment loss+output loss. Here, the alignment loss is computed by alignment loss calculation 312 as the L1 loss between the ground truth embeddings 304B and the projected features 322. The output loss is computed by output loss calculation 314 as the cross-entropy loss between the ground truth outputs 304A and the model outputs 324.

### 3.3 Adaptation Layer

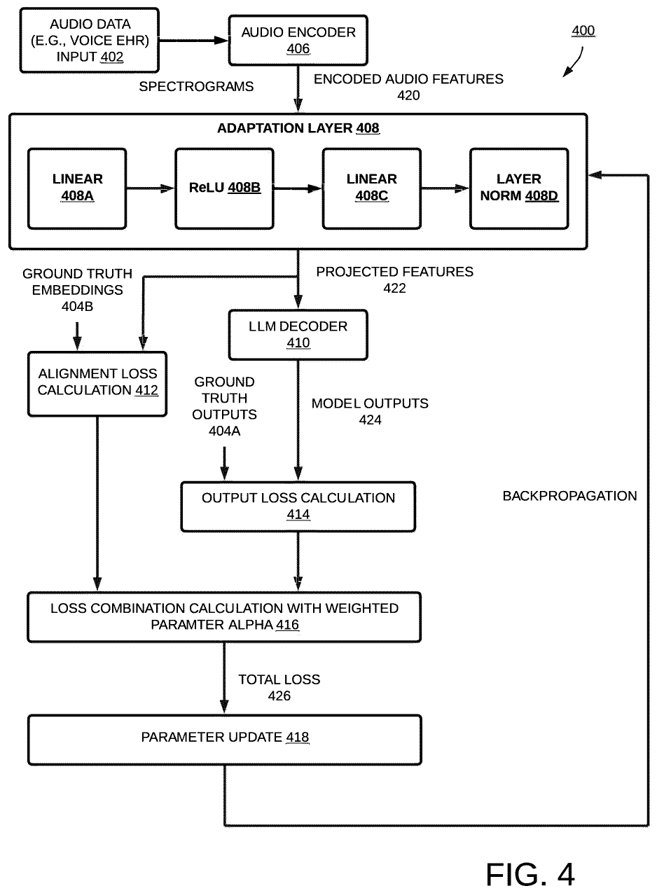

FIG. 4 illustrates an adaptation layer 408 comprising two fully connected linear layers 408A and 408C, a ReLU activation layer 408B, and a layer normalization layer 408D for projecting encoded features 420 according to one or more embodiments of a unified model 400 with a single encoder-decoder architecture for a domain-specific application. Like reference numbers in FIG. 4 refer to corresponding elements described above with respect to FIG. 1. To avoid unnecessarily obscuring an embodiment, description of some elements described above with respect to FIG. 1 is not repeated below.

The adaptation layer 408 implements a four-component architecture for transforming encoded audio features 420 into a format compatible with the language model decoder 410's embedding space.

The first fully connected linear layer 408A transforms encoded audio features 420 through a linear transformation matrix. The transformation converts the features into a hidden representation with 2,048 dimensions (or other suitable number of dimensions). The layer 408A includes trainable weights and biases updated during training based on the total loss 426. Matrix multiplication operations transform input vectors into the 2,048-dimensional space while maintaining sufficient information capacity for complex audio patterns.

The ReLU activation layer 408B applies element-wise, non-linear activation to the hidden representation from the first fully connected layer 408A. The layer 408B maintains positive values unchanged while setting negative values to zero. This non-linear transformation enables learning complex patterns between encoded audio features 420 and the decoder 410's embedding space. The layer 408B's position between two fully connected layers 408A and 408C prevents the architecture from collapsing into a purely linear transformation.

The second fully connected linear layer 408C projects the ReLU-activated features into the language model decoder 410's embedding space dimensions. The layer 408C implements a linear transformation matrix with learned weights and biases. The transformation ensures processed features maintain semantic meaning while conforming to the decoder 410's dimensional requirements. Like layer 408A, the layer 408C's parameters optimize via the total loss 426 for both alignment loss 412 and output loss 414 during training.

The layer normalization layer 408D normalizes the second fully connected layer 408C's output features. The layer 408D calculates mean and variance across feature dimensions for a training example. The normalization process transforms features to zero mean and unit variance. This normalization stabilizes training by maintaining consistent feature scales, useful given the multi-loss training approach. The layer 408D's position component ensures properly normalized features enter the decoder 410.

### 3.4 Output Loss

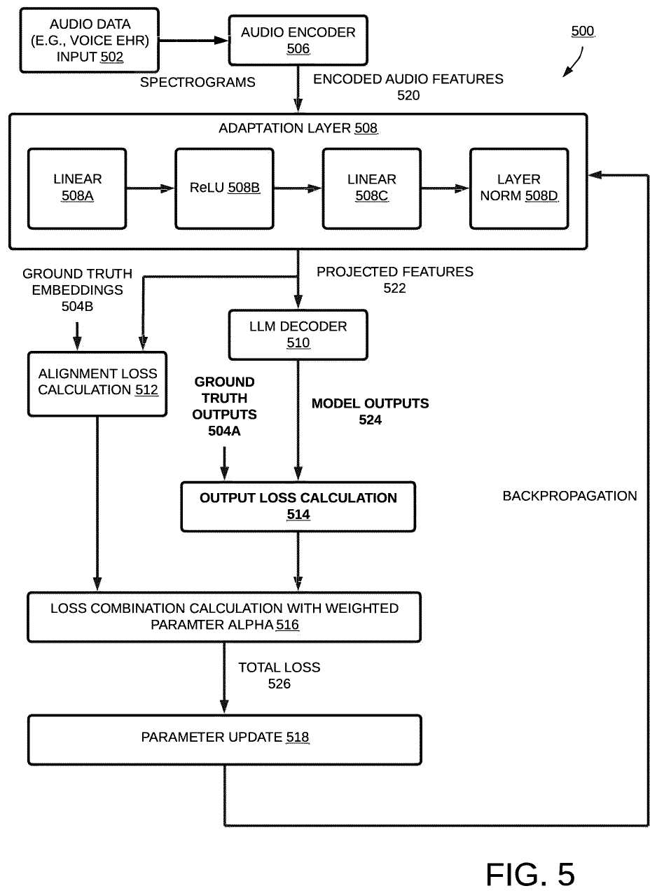

FIG. 5 illustrates computing output loss 514 as cross-entropy loss between probability distributions of model outputs 524 and ground truth outputs 504A according to one or more embodiments of a unified model 500 with a single encoder-decoder architecture for a domain-specific application. Like reference numbers in FIG. 5 refer to corresponding elements described above with respect to FIG. 1. To avoid unnecessarily obscuring an embodiment, description of some elements described above with respect to FIG. 1 is not repeated below.

A cross-entropy loss computation measures differences between probability distributions of model outputs 524 and ground truth outputs 504A. The output loss calculation 514 implements this computation by comparing two specific probability distributions.

The first probability distribution comes from the language model decoder 510. This distribution represents the decoder 510's predictions across possible output tokens. The second probability distribution derives from the ground truth outputs 504A. The ground truth distribution represents the correct or expected outputs for the given audio input.

The cross-entropy loss calculation quantifies how closely the decoder 510's predicted distribution matches the ground truth distribution. A lower cross-entropy value indicates better alignment between these distributions. The calculation weights errors based on the ground truth distribution, providing appropriate gradients for adaption layer 508 optimization.

Model outputs 524 and ground truth outputs 504A feed into the output loss calculation 514 where the cross-entropy computation occurs. The model outputs 524 include the decoder 510's predicted probability distribution. The ground truth outputs 504A provide the reference probability distribution. The output loss calculation 514 processes these distributions through the cross-entropy function to generate a scalar loss value.

The cross-entropy loss serves a specific purpose in domain-specific speech and output recognition tasks. The loss calculation helps optimize accurate transcription of domain-specific terminology by penalizing mismatches in probability distributions particularly heavily when the decoder 510 assigns low probability to correct domain-specific terms. This targeted optimization improves the decoder 510's ability to handle specialized vocabulary in domain-specific audio.

The computed cross-entropy loss feeds into the loss combination calculation 516 for combination with the alignment loss 512. This combination enables simultaneous optimization of both distribution matching accuracy and feature space alignment during adaptation layer 508 parameter updates.

### 3.5 Targeted Training

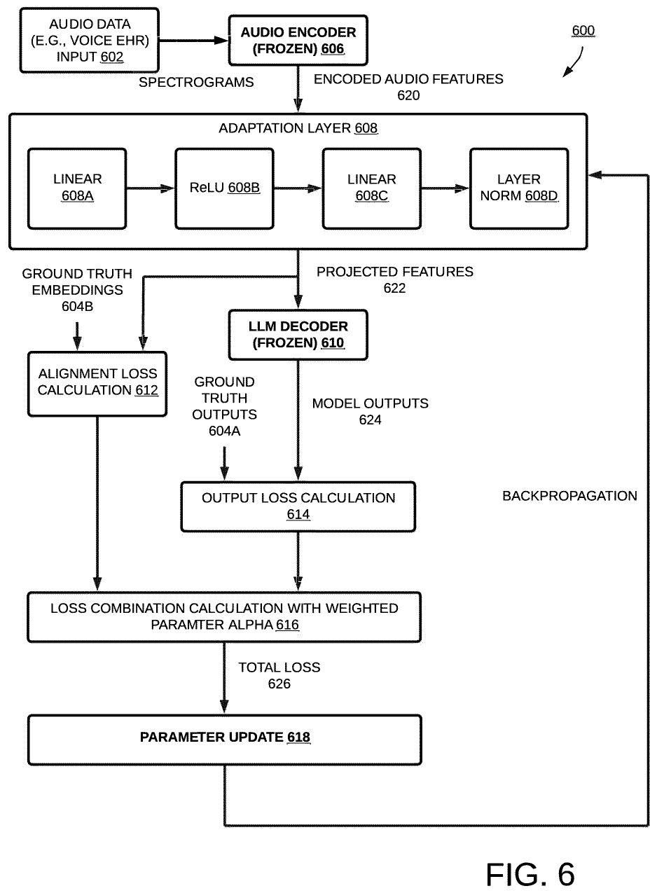

FIG. 6 illustrates updating adaptation layer 608 parameters while maintaining fixed (frozen) parameters for the audio encoder 606 and language model decoder 610 according to one or more embodiments of a unified model 600 with a single encoder-decoder architecture for a domain-specific application. Like reference numbers in FIG. 6 refer to corresponding elements described above with respect to FIG. 1. To avoid unnecessarily obscuring an embodiment, description of some elements described above with respect to FIG. 1 is not repeated below.

The parameter update block 618 represents a component in the training method that selectively updates model parameters of the adaptation layer 608 based on the calculated total loss 626. The parameter update block 618 receives the combined loss value 626 from the loss combination calculation components 616 and executes a parameter update strategy.

The parameter update component 618 implements an innovation of the training approach by maintaining fixed parameters for both the audio encoder 606 and language model decoder 610 while updating the adaptation layer 608 parameters. This selective update mechanism preserves the pre-trained capabilities of the encoder 606 and decoder 610 models while optimizing the intermediate adaptation layer.

The parameter update component 618 performs gradient-based updates using the total loss 626, which incorporates both alignment loss 612 and output loss 614 components. The parameter updates are specifically targeted at the adaptation layer 608's four-component architecture, including the fully connected linear layers 608A and 608C, ReLU activation 608B, and normalization layer 608D.

The parameter update component 618 connects back to the adaptation layer 608 in the training flow, creating a feedback loop that iteratively refines the adaptation layer 608's ability to project encoded audio features 620 into the appropriate decoder embedding space. The focused parameter updating approach allows the adaptation layer 608 to optimize the translation between audio 606 and language model 610 representations while maintaining computational efficiency.

The parameter update component 618 implementation supports the training process's goal of finding an optimal projection between the audio encoder 606's output space and the language model decoder 610's input space through targeted parameter updates of the adaptation layer 608 components

### 3.6 RAG Implementation

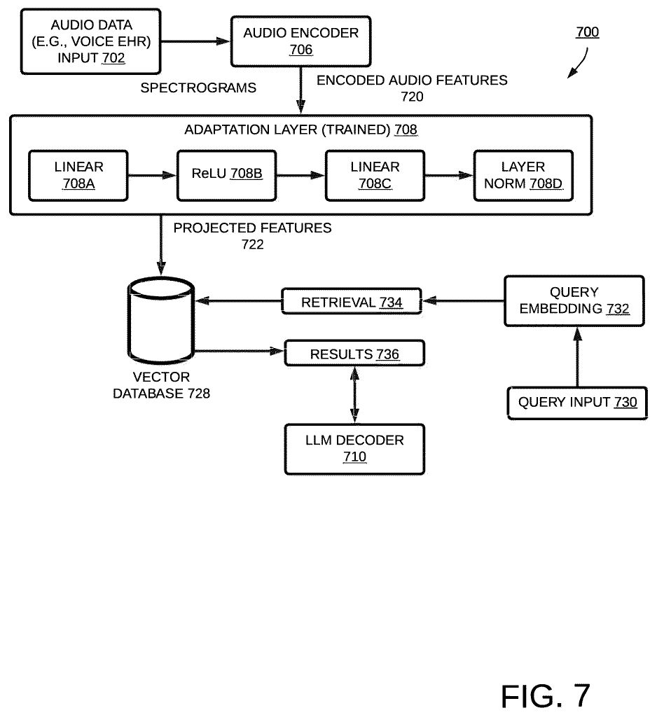

FIG. 7 illustrates a retrieval augmented generation (RAG) system 700 storing projected features 722 in a vector database 728 and retrieving relevant features based on similarity between query embeddings and stored features according to one or more embodiments. Like reference numbers in FIG. 7 refer to corresponding elements described above with respect to FIG. 1. To avoid unnecessarily obscuring an embodiment, description of some elements described above with respect to FIG. 1 is not repeated below.

The vector database 728 stores projected features 722 processed through the trained adaptation layer 708 from encoded audio data 702. The vector database 728 enables efficient similarity-based retrieval operations without intermediate text conversion steps. The database structure supports high-dimensional vector storage and efficient similarity search operations.

The query input 730 accepts natural language queries for searching relevant audio content. The query input 730 serves as the interface where queries enter the system for processing. The query input 730 feeds into the query embedding block 732 for embedding generation.

The query embedding component 732 transforms textual queries into embeddings compatible with LLM decoder 710's embedding space. The query embedding component 732 generates embeddings in a dimensional space compatible with the projected features 722 created by the trained adaptation layer 708. These query embeddings enable direct semantic comparison between text queries and audio content. The embeddings serve as reference vectors for searching the vector database 728.

The retrieval component performs similarity-based matching between query embeddings and stored projected features 722. The retrieval component 734 implements vector similarity calculations to identify relevant audio segments based on projected feature representations 722. The retrieval component 734 pulls candidate projected features from the database based on similarity scores.

The retrieved results component 736 includes the final outputs generated by the language model decoder 710 when processing retrieved audio segments represented by projected features retrieved from the vector database 728. The block processes projected features retrieved through similarity matching to generate outputs corresponding to relevant audio content. The retrieved results maintain semantic relationships with the original audio through the adaptation layer 708's projection process.

### 4. Method for Training a Unified Neural Network Model With a Single Encoder-Decoder Architecture for a Domain-Specific Application

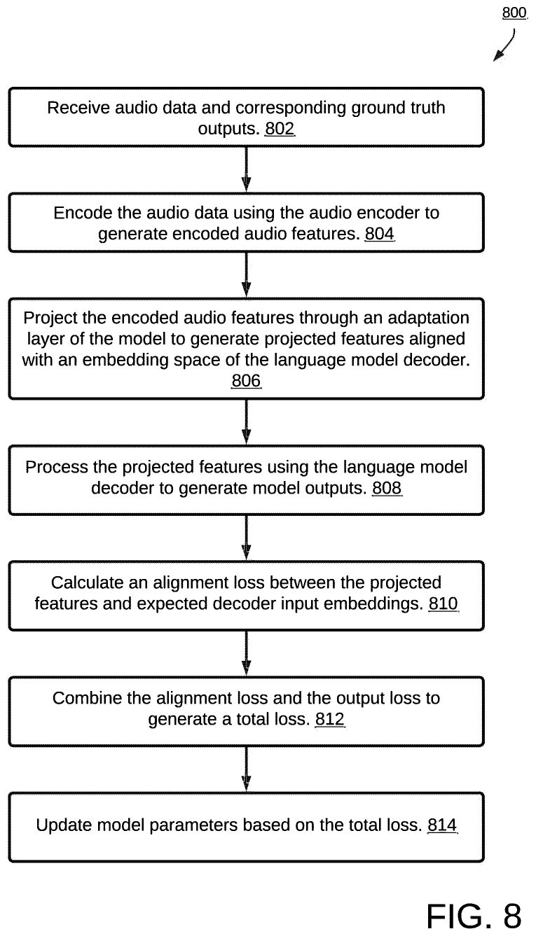

FIG. 8 is a flowchart of a method 800 for training a unified neural network model with a single encoder-decoder architecture for a domain-specific application in accordance with one or more embodiments.

The method 800 describes a training approach for a unified audio processing model that combines an audio encoder with a language model decoder through an adaptation layer. The training process begins by accepting audio recordings paired with their corresponding ground truth outputs, such as transcriptions or medical diagnoses.

The audio encoder processes the input audio data to extract encoded audio features. In one implementation, these features capture acoustic patterns within 20 ms segments of the audio input. An adaptation layer then transforms the encoded audio features through multiple processing steps, including dimension reduction, non-linear activation, and normalization, to align with the language model decoder's embedding space.

The language model decoder processes these projected features to generate the model's outputs. The training method employs two distinct loss calculations. The alignment loss measures how well the projected features match the expected decoder input embeddings. The output loss compares the model's final outputs against the ground truth data.

These two loss components are combined using a weighted scheme with tunable parameters to create a total loss metric. The model parameters are then updated through backpropagation based on this total loss. The adaptation layer parameters receive updates to improve both dimensional alignment and semantic mapping between the audio encoder and language model decoder.

The training approach enables the model to learn both accurate transcription and proper embedding space alignment simultaneously. In one implementation, this dual optimization helps the model achieve a 20% lower error rate compared to existing solutions while maintaining efficiency through a unified architecture.

Returning to the top of the method 800, the operation of receiving audio data and corresponding ground truth outputs (Operation 802) refers to the input acquisition phase of the model training process where both audio training samples and their correct transcriptions or expected outputs are obtained. Audio data includes digitized sound recordings sampled in one implementation at 16,000 Hz with 20 ms segments. In one implementation, these recordings include medical conversations, dictations, and simulated doctor-patient interactions. In one implementation, the audio data includes both speech and non-speech sounds such as coughs and breathing patterns.

The ground truth outputs are the correct or expected results that correspond to an audio input. For speech recognition tasks, ground truth outputs are accurate transcriptions of the spoken content. In one implementation, the training data includes one million data points of medical-specific content, featuring actors reading prescriptions and simulated medical conversations with verified transcriptions.

The receiving operation (Operation 802) serves as the initial step in the training pipeline. Paired audio-text data is accepted where an audio segment has an associated validated transcription. This paired data enables supervised learning by providing examples of correct input-output relationships.

In one implementation, the audio data and ground truth pairs are structured to support the unified model's medical domain focus. Training samples emphasize medical terminology, medication names, and clinical conversations. The receiving operation (Operation 802) processes these specialized training examples to enable the model to learn domain-specific patterns and vocabulary.

The operation of encoding the audio data using the audio encoder to generate encoded audio features (Operation 804) describes the process of transforming raw audio input data into a structured representation of acoustic features using an audio encoder component.

An audio encoder is a neural network component that processes audio signals to extract meaningful features. In one implementation, the audio encoder processes audio segments of up to 30 seconds in length. In one implementation, the encoder analyzes audio in 20-millisecond segments, with a segment corresponding to a specific feature vector.

The encoding process converts the raw audio waveform into encoded audio features that capture relevant acoustic characteristics. These encoded audio features represent various aspects of the audio signal, such as frequency patterns, temporal dynamics, and acoustic properties. The audio encoder specifically transforms these audio segments into high-dimensional feature vectors.

The encoded audio features serve as the intermediate representation between the raw audio input and the adaptation layer. This encoding step is useful, for it transforms the audio data into a format that can be further processed by subsequent components of the model. The encoder generates feature vectors that maintain the temporal relationships of the original audio while extracting meaningful acoustic patterns.

In one implementation, the encoding operation processes audio at a sampling rate of 16,000 Hz, capturing 20-millisecond voice segments. The encoder concatenates sequential 20-millisecond segments into longer vectors to maintain temporal context. These encoded audio features form the basis for subsequent processing through the adaptation layer and ultimately the language model decoder.

The projection operation (Operation 806) transforms encoded audio features into a format compatible with the language model decoder's embedding space through an adaptation layer. The adaptation layer includes multiple components working together to bridge the dimensional and representational gap between audio encodings and language model embeddings.

In an implementation, the adaptation layer architecture implements a four-layer structure. A first fully connected linear layer transforms the acoustic features into a 2,048-dimensional hidden space. A ReLU activation layer then applies non-linearity to capture complex patterns. A second fully connected linear layer maps the hidden representations to match the language model decoder's embedding space dimensions. Finally, a layer normalization component stabilizes the training process.

The adaptation layer serves as a translation mechanism between the audio domain and language model domain. The projected features maintain semantic alignment with the original audio content while being formatted in a way the language model decoder can effectively process. This alignment enables the decoder to generate accurate text outputs from the audio representations.

The projection operation (Operation 806) represents an innovation over existing sequential pipeline approaches. The adaptation layer creates a unified model architecture rather than requiring separate models for audio processing and language understanding. This unified approach reduces computational overhead while maintaining or improving accuracy in audio recognition tasks.

The operation of processing the projected features using the language model decoder to generate model outputs (Operation 808) describes the step where projected audio features are processed through a language model decoder to produce final outputs during model training.

A language model decoder is a neural network component that transforms input embeddings into human-readable text or other desired outputs. In one implementation, the decoder is specifically a decoder LLM rather than an encoder-decoder model. The decoder processes the projected features, which are audio embeddings that have been transformed by the adaptation layer to match the decoder's expected embedding space dimensionality (e.g., 2048 dimensions).

The projected features serve as input embeddings for the language model decoder. The decoder applies its trained weights and attention mechanisms to these embeddings. The decoder uses cross attention mechanisms rather than group attention to process these inputs. Through multiple neural network layers, the decoder transforms these embeddings into final model outputs.

Model outputs represent the decoder's predictions or generations based on the input audio features. For speech recognition tasks, these outputs would typically be text transcriptions. The outputs serve as predictions that can be compared against ground truth values for calculating loss during training.

The processing step is useful for the training loop, for it generates the predictions needed to compute output loss against ground truth values. This loss computation helps optimize both the decoder and adaptation layer parameters during training.

The calculation of alignment loss between projected features and expected decoder input embeddings (Operation 810) is a useful component of the model's training process.

Alignment loss refers to a mathematical measure of how well the projected features from the adaptation layer match the expected input format of the language model decoder. Projected features are the output vectors produced by passing encoded audio features through the adaptation layer. Expected decoder input embeddings represent the ideal vector representations that the language model decoder is designed to process.

The alignment loss combines two distinct loss metrics. The first metric is L1 loss, which measures the absolute difference between vector components. The second metric is cosine similarity loss, which measures the angular difference between vectors in high-dimensional space. These loss components ensure both magnitude and directional alignment between the projected features and decoder embeddings.

The calculation serves to guide the adaptation layer in learning the optimal transformation between the audio encoder's feature space and the language model decoder's embedding space. This alignment process enables the model to effectively “translate” audio representations into a format the language model can understand. The alignment loss helps create meaningful associations between spoken sounds and their corresponding text representations.

In an implementation, the alignment loss calculation operates on 2,048-dimensional vectors, which represents the chosen dimensionality for the adaptation layer's output space. This dimensionality was determined in one implementation through hyperparameter optimization experiments. The loss calculation incorporates layer normalization to maintain stable training dynamics.

The operation of calculating an output loss between the model outputs and the ground truth outputs (Operation 812) refers to computing a measure of difference or error between what the model produces (model outputs) and the known correct answers (ground truth outputs) during the training process.

Model outputs are the final predictions or transcriptions generated by the language model decoder after processing the projected audio features. These outputs represent the model's attempt to convert the input audio into appropriate text or classifications.

Ground truth outputs are the known correct answers or reference transcriptions provided in the training data. In one implementation, these come from the one million data points of medical-specific training data that includes actors reading prescriptions and simulated doctor-patient conversations with verified transcriptions.

The output loss calculation quantifies how far the model's predictions deviate from the correct answers. This loss component focuses specifically on the final output quality, distinct from the alignment loss that handles intermediate representations. The output loss helps guide the model toward producing more accurate transcriptions and classifications, particularly for medical terminology and complex medical conversations.

This output loss is combined with an alignment loss using a weighted approach with a tunable alpha parameter. Together, these loss components form the total loss used to update the model parameters during training.

The operation of combining the alignment loss and the output loss to generate a total loss (Operation 814) refers to the mathematical process of merging two distinct loss functions into a single optimization objective for training the neural network model.

A loss function measures how well a model performs by calculating the difference between predicted and expected outputs. In this context, the total loss combines two components: (1) The alignment loss measures how closely the projected features from the adaptation layer match the expected decoder input embeddings in the language model's embedding space, and (2) The output loss measures how accurately the model's final outputs match the ground truth outputs, such as transcribed text. The combination involves a weighted sum of these two losses, where an alpha parameter controls their relative importance. In an implementation, the alpha parameter is determined through hyperparameter optimization using cross-validation and grid search methodology. This weighting allows engineers to balance the importance of feature alignment versus output accuracy during training.

The total loss serves as the primary optimization objective that guides parameter updates during model training. By incorporating both alignment and output losses, the model learns to both accurately project audio features into the decoder's embedding space and generate correct outputs simultaneously.

This combined loss approach differs from traditional audio recognition systems that only optimize for output accuracy. The dual loss mechanism helps ensure the adaptation layer effectively bridges the audio encoder and language model decoder while maintaining high transcription accuracy.

The operation of updating model parameters based on the total loss (Operation 814) refers to the process of adjusting the trainable parameters within the neural network model using backpropagation based on the computed total loss value. Model parameters are the weights and biases in the neural network that determine how input data is transformed through the network layers.

The total loss combines two components, the alignment loss between projected features and expected decoder embeddings and the output loss between model outputs and ground truth outputs. This combined loss provides a comprehensive signal for optimizing both the adaptation layer's projection quality and the overall model output accuracy.

The updating process uses gradient descent optimization techniques. The gradients of the total loss with respect to a model parameter are computed. These gradients indicate how a parameter should be adjusted to reduce the total loss. The model parameters are then updated by taking steps in the opposite direction of the gradients.

In one implementation, the parameters being updated span multiple components of the model architecture. These include the audio encoder parameters, the adaptation layer parameters (encompassing fully connected layers, ReLU activation, and layer normalization), and the language model decoder parameters. The magnitude of parameter updates is controlled by a learning rate hyperparameter. In another implementation, the parameters being updated are just those of the adaptation layer and not of the audio encoder and the language model decoder which are frozen in pre-trained form during training of the adaption layer.

This parameter updating process occurs iteratively during training. An iteration processes a batch of audio data and ground truth pairs, computes the total loss, and updates the parameters accordingly. Through many iterations, the model parameters converge toward values that minimize the total loss and improve model performance.

### 5. Example Embodiment

A detailed example is described below for purposes of clarity. Components and/or operations described below should be understood as one specific example that may not be applicable to certain embodiments. Accordingly, components and/or operations described below should not be construed as limiting the scope of any of the claims.

In one embodiment, audio encoding and language model decoding are integrated to process medical conversations and diagnostic audio signals. Audio data, such as patient-doctor conversations or respiratory sounds, serves as input along with corresponding ground truth outputs like medical transcriptions or diagnostic labels.

An audio encoder processes the input audio data to extract relevant acoustic features including speech patterns, breathing sounds, and vocal biomarkers. The encoded audio features include high-dimensional temporal and spectral characteristics that capture clinically relevant information.

An adaptation layer projects the encoded audio features into an embedding space aligned with the language model decoder. The projection involves dimensionality reduction while preserving important acoustic patterns. Cross-modal attention mechanisms in the adaptation layer create explicit mappings between acoustic features and medical terminology or diagnostic outputs.

The language model decoder processes the projected features to generate outputs, such as medical transcriptions or diagnostic predictions. The decoder leverages pre-trained language understanding capabilities to interpret the acoustic patterns in a medical context.

Two loss components are calculated during training. An alignment loss measures how well the projected audio features match the expected decoder input embeddings, ensuring effective cross-modal mapping. An output loss compares the model's predictions against ground truth medical transcriptions or diagnoses.

The alignment and output losses combine into a total loss for updating model parameters. The training methodology freezes the audio encoder and language model while optimizing the adaptation layer parameters. This approach maintains computational efficiency while enabling the model to learn effective mappings between acoustic and medical domain representations.

The unified architecture provides advantages for medical applications by processing audio biomarkers and linguistic content simultaneously. Direct projection of audio features through the adaptation layer enables capture of subtle acoustic patterns relevant for diagnosis while maintaining accurate transcription of medical terminology.

### 6. Practical Applications, Advantages, and Improvements

In one or more embodiments, the model architecture integrates ASR and language model capabilities through a unified encoder-decoder design, eliminating sequential processing requirements. The system combines an audio encoder, a custom adaptation layer, and a decoder-based LLM to process audio and text inputs simultaneously. Audio inputs encompassing voice tone and speech patterns merge with textual data like clinical notes in a single processing pipeline, reducing computational overhead.

In one or more embodiments, multimodal integration occurs through specialized audio encoding aligned with text embeddings. The audio encoder extracts low-level acoustic features while maintaining alignment with LLM embeddings, creating unified multimodal representations. The combined processing captures nuanced health markers, including stress levels, emotional tone variations, and respiratory irregularities, beyond traditional text-only analysis capabilities.

In one or more embodiments, the custom audio encoder implements a 1D convolutional layer for dimensionality reduction of raw audio inputs. Activation functions process the reduced features before linear projection maps the audio representations to match the LLM embedding space. This projection enables direct multimodal processing by ensuring audio and text features occupy the same vector space.

In one or more embodiments, parallel interpretation of audio and text modalities occurs through alignment between audio encoder outputs and LLM text embeddings. The aligned representations capture clinical intent, condition markers, and emotional states across modalities. Voice feature analysis combines with medical transcription processing to enhance diagnostic capabilities, particularly for conditions with vocal biomarkers, like Parkinson's disease and respiratory disorders.

In one or more embodiments, prompt engineering mechanisms provide flexible output generation tailored to clinical needs. Physicians can modify prompts to generate summaries, diagnostic insights, or detailed medical narratives without model retraining. The adaptable output generation supports diverse clinical requirements from basic transcription to advanced diagnostic assistance within a single system.

In one or more embodiments, audio-driven RAG leverages the unified embedding space to incorporate audio features in real-time information retrieval. The native audio encoding enables dynamic feature extraction and integration during response generation. Retrieved audio information enhances diagnostic predictions, clinical summaries, and treatment recommendations by incorporating voice-based medical record data containing critical diagnostic nuances.

In one or more embodiments, the architecture serves multiple healthcare applications through unified audio-text processing capabilities. Clinical documentation, transcription, and diagnostic support functions operate within a consolidated framework. The multimodal design maximizes data utilization while minimizing requirements for separate specialized models across different healthcare tasks.

### 7. Example LLM Architecture

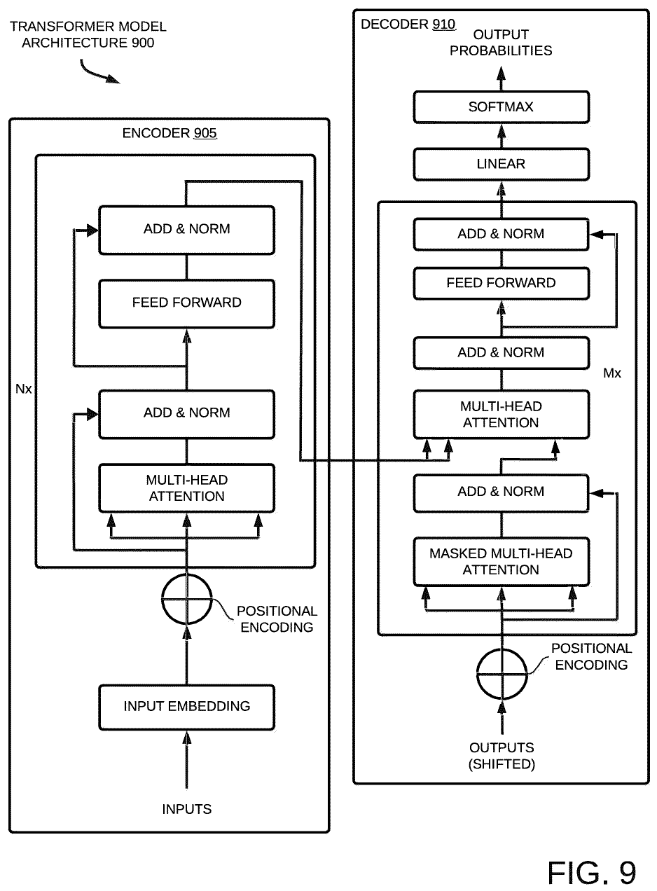

FIG. 9 illustrates an example transformer model architecture 900 that may be used in the implementation of an LLM according to an embodiment of the present disclosure. For example, decoder 910, or components or aspects thereof, may be used in an implementation of LLM decoder 110 and the corresponding LLM decoders of the other figures.

The transformer model architecture 900 may be a neural network design for natural language processing. At its core, the transformer 900 may encompass an encoder 905 and a decoder 910, both leveraging self-attention mechanisms. The architecture 900 may begin with an input embedding layer that converts tokens into high-dimensional vector representations that may range, for example, from 128 to 1024 dimensions. These embeddings may be augmented with positional encodings to retain sequence order information.

The transformer model architecture 900's input embedding layer serves as the initial processing stage for converting discrete tokens into continuous vector representations. These dense embeddings may occupy a high-dimensional space, with dimensionality configurations ranging from 128 to 1024, allowing for rich semantic representation of input tokens. The embedding process maps each token to a unique vector that captures the token's semantic properties in the continuous space. Positional encodings are subsequently added to these token embeddings through element-wise addition, introducing position-dependent signals that encode sequential information. These positional encodings can be implemented using sinusoidal functions or learned parameters, enabling the model to differentiate between tokens based on their positions in the sequence. The combined embeddings preserve both semantic content and sequential order, forming a foundation for the subsequent self-attention mechanisms. This embedding strategy addresses the inherent limitation of transformer architectures in processing sequential data, as the self-attention mechanism alone is position-agnostic.

The transformer 900 may include a multi-head, self-attention mechanism. This may allow the model 900 to simultaneously attend to different parts of the input sequence, capturing various types of relationships and dependencies. Each attention head may compute query, key, and value vectors, enabling the model to focus on relevant parts of the input when processing each token. Following the attention layers, the architecture 900 may incorporate feed-forward neural networks with multiple layers and non-linear activation functions.

The multi-head self-attention mechanism forms a component of the transformer architecture 900, enabling parallel processing of input sequence elements. Each attention head operates as an independent attention mechanism, computing three distinct matrices: queries (Q), keys (K), and values (V) through learned linear transformations of the input embeddings. The parallel nature of multiple attention heads allows the model to capture diverse relationship patterns within the same input sequence simultaneously, such as syntactic dependencies, semantic relationships, and long-range contextual connections. The attention computation follows the scaled dot-product attention formula, where the dot product between queries and keys determines alignment scores, followed by scaling and softmax normalization to produce attention weights. These weights are then applied to the value vectors, creating context-aware representations. The feed-forward neural networks following the attention layers include two linear transformations with a non-linear activation function (e.g., ReLU or GELU) between them, processing each position's output independently. This combination of self-attention and position-wise feed-forward networks enables the model to alternate between gathering contextual information across the sequence and applying complex transformations to individual positions, creating a powerful mechanism for sequence processing.

A masked, multi-head attention mechanism in the decoder 910 of a transformer model 900 may be designed to prevent the model from attending to future tokens during sequence generation. In this mechanism, multiple attention heads may operate in parallel, each computing query (Q), key (K), and value (V) matrices from the input embeddings. The attention scores may be calculated as the dot product of Q and K, scaled by the inverse square root of the dimension of the keys. A lower triangular mask may be applied to these attention scores before softmax normalization, effectively setting the upper triangular elements to negative infinity. This masking may ensure that each position can only attend to previous positions in the sequence, maintaining the autoregressive property of the decoder. The masked attention scores may then be used to compute a weighted sum of the value vectors. The outputs from the heads may be concatenated and linearly transformed to produce the attention output. This process may allow the decoder to generate tokens sequentially while considering only the previously generated tokens, thus preserving the causal nature of language modeling.

The masked multi-head attention mechanism in the transformer's decoder 910 implements causal masking to enforce autoregressive generation during sequence processing. Each attention head performs linear projections to create query (Q), key (K), and value (V) matrices from input embeddings through learned weight matrices WQ, WK, and WV respectively. The attention computation follows the formula Attention (Q, K, V)=softmax(QK^{T}/√dk)V, where dk represents the dimensionality of the key vectors. A lower triangular mask matrix gets added to the attention scores before softmax normalization. This mask sets all upper triangular elements to negative infinity (−∞), effectively zeroing out these positions after the softmax operation. The masking operation ensures strict causality by preventing any position from attending to future positions in the sequence during both training and inference. Following the masked attention computation, the outputs from multiple attention heads are concatenated along the feature dimension and projected through a final linear transformation WO to produce the layer's output. This output maintains the temporal causality required for autoregressive generation while still allowing each position to attend to all previous positions in the sequence. The parallelized implementation of multiple attention heads enables the model to capture various aspects of the sequence history simultaneously, while the masking mechanism maintains the sequential nature of language generation.

To maintain stable training and mitigate vanishing gradients, the transformer 900 may employ layer normalization after each sub-layer (self-attention and feed-forward networks) and may introduce residual connections. These residual connections may allow unimpeded information flow through the network. The model may include multiple (Nx) encoder and decoder (Mx) layers stacked on top of each other, increasing its capacity to learn complex language patterns.

The transformer architecture incorporates stabilization techniques through layer normalization and residual connections. Layer normalization is applied after both the self-attention and feed-forward network sub-layers, normalizing the activations across the feature dimension for each token position. The normalization process computes the mean and variance of the features, then scales and shifts the normalized values using learned parameters gamma and beta, effectively standardizing the feature distributions throughout the network. Residual connections, implemented as skip connections, add the input of each sub-layer to the transformed output, creating direct paths for gradient flow during backpropagation. The combination of these components follows the formula LayerNorm(x+Sublayer(x)), where x represents the input and Sublayer represents either the self-attention or feed-forward network.

The stacking of multiple encoder and decoder layers increases the model's capacity logarithmically with respect to sequence length, enabling the capture of hierarchical patterns in language. Each additional layer in the stack provides an opportunity for more abstract feature representation, with lower layers capturing local patterns and higher layers learning more complex, global dependencies. The interaction between layer normalization and residual connections creates a well-conditioned optimization landscape, facilitating stable training of deep transformer networks while mitigating the vanishing gradient problem that commonly affects deep neural architectures.

The output layer may involve a linear transformation followed by a softmax function, producing probability distributions over the vocabulary for text generation tasks. This architecture 900's design may allow for efficient parallel processing of input sequences, making it particularly suitable for handling the extensive datasets used in training LLMs.

The output layer of the transformer architecture implements a vocabulary-sized classification mechanism through a linear transformation followed by softmax activation. The linear transformation projects the decoder's hidden states onto a vocabulary-sized space using a weight matrix W∈ [symbol] \hat{ }(d_model×|V|), where d_model represents the model's hidden dimension and |V| represents the vocabulary size. The subsequent softmax function normalizes these logits into a proper probability distribution across the entire vocabulary, computing P(token_i)=exp(z_i)/Σ_j exp(z_j), where z_i represents the logit for the i-th vocabulary token. This architectural design enables efficient batch processing of input sequences through matrix multiplications, leveraging modern hardware accelerators like GPUs and TPUs. The parallel computation capability stems from the self-attention mechanism's ability to process all sequence positions simultaneously during the forward pass, requiring only O(1) sequential operations compared to the O(n) operations needed in recurrent architectures. The model's parallelization efficiency scales particularly well with increasing sequence lengths, making the architecture advantageous for processing the extensive datasets used in large language model training, which often include billions of tokens across diverse domains and languages.

In one or more embodiments, architectural variations enhance or modify the standard transformer design for LLM implementations. The Sparse Transformer introduces structured sparsity patterns in the attention mechanism, reducing the quadratic memory complexity to linear complexity through fixed attention patterns. This modification enables processing of much longer sequences while maintaining model quality. Reformer architectures employ locality-sensitive hashing for attention computation, approximating full attention while significantly reducing memory requirements. The Performer architecture replaces the attention mechanism with kernel-based formulations using random feature decomposition, achieving linear complexity in both compute and memory.

Alternate positional encoding schemes offer various trade-offs. Rotary positional embeddings (RoPE) inject positional information through rotation matrices applied to token embeddings, providing better relative position modeling. Alibi position embeddings add learned bias terms to attention scores, enabling better extrapolation to sequences longer than those seen during training. Some architectures eliminate explicit positional encodings entirely, instead relying on position-aware linear attention mechanisms.

Architecture modifications also target specific computational bottlenecks. Flash Attention optimizes attention computation through careful management of GPU memory access patterns. Mixture of Experts (MoE) architectures incorporate specialized sub-networks activated based on input patterns, increasing model capacity without proportional computation increases. The GLU (Gated Linear Unit) variants replace standard feed-forward networks with gated mechanisms, providing more flexible function approximation. Multi-query attention reduces memory bandwidth requirements by sharing key and value projections across attention heads while maintaining separate query projections.

Some architectures focus on improved training dynamics. DeepNorm modifies the layer normalization scheme to enable stable training of deeper networks. Gradient checkpointing strategies reduce memory requirements during training by recomputing certain activations during backpropagation. State space models offer an alternative to attention mechanisms entirely, using linear state space equations to model sequence relationships with improved computational efficiency.

Alternative architectures for LLM implementation encompass distinct paradigms beyond transformers. Recurrent Neural Networks (RNNs), particularly variants like Long Short-Term Memory (LSTM) networks and Gated Recurrent Units (GRUs), process sequences sequentially through hidden state updates. These architectures maintain explicit temporal dependencies through gating mechanisms, controlling information flow between timesteps. LSTM networks employ three gates—input, forget, and output—along with a memory cell to regulate information persistence. GRUs simplify this structure with reset and update gates while maintaining comparable performance.

Convolutional Neural Networks (CNNs) offer another approach through hierarchical feature extraction. Temporal Convolutional Networks (TCNs) apply dilated convolutions to capture long-range dependencies while maintaining autoregressive properties. The hierarchical structure of TCNs enables parallel processing within each layer while preserving causal relationships. Quasi-Recurrent Neural Networks (QRNNs) combine convolutional and recurrent approaches, using convolution for parallel feature extraction followed by a lightweight recurrent pooling mechanism.

Memory-augmented architectures present another paradigm. Neural Turing Machines (NTMs) and Differentiable Neural Computers (DNCs) supplement neural processing with external memory arrays, accessed through attention-like mechanisms. These architectures separate computation from memory storage, enabling more explicit modeling of long-term dependencies. Memory Networks similarly incorporate dedicated memory components but with more structured addressing mechanisms.

Continuous-time models offer an alternative perspective on sequence processing. Neural Ordinary Differential Equations (Neural ODEs) model sequence evolution as a continuous-time dynamical system, solving differential equations to process inputs. This approach enables variable timestep processing and potentially more natural handling of temporal relationships. Similarly, Neural Controlled Differential Equations (Neural CDEs) extend this framework to handle irregular time series data while maintaining end-to-end differentiability.

Graph Neural Networks (GNNs) provide yet another alternative by modeling sequences as structured graphs. This approach enables explicit modeling of hierarchical relationships and long-range dependencies through message passing between nodes. Graph-based architectures can capture complex dependencies that may be difficult to model with purely sequential approaches, though these architectures may require careful design of graph structure and update rules.

### 8. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. Custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 9. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

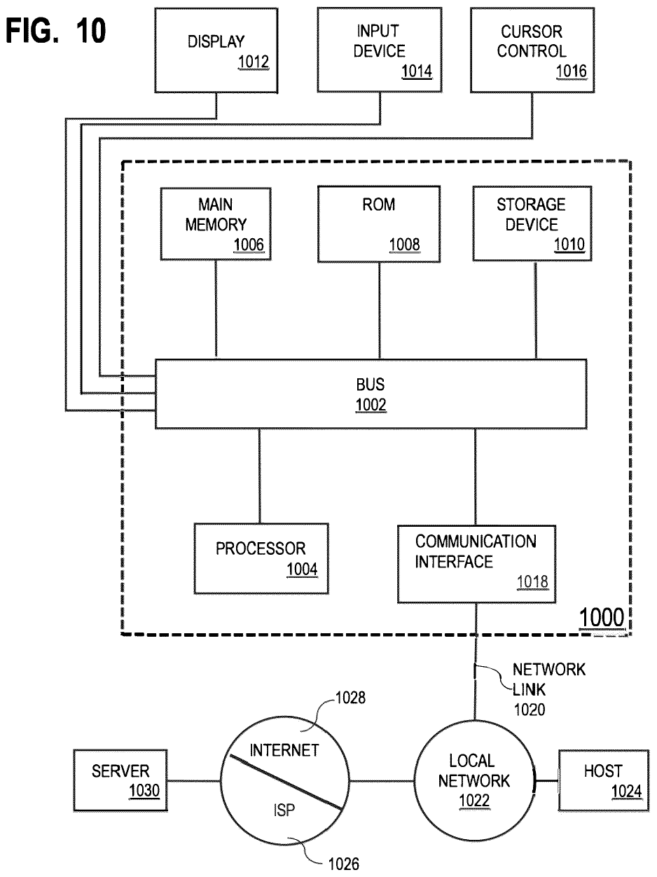

For example, FIG. 10 is a block diagram that illustrates a computer system 1000 upon which an embodiment of the disclosure may be implemented. Computer system 1000 includes a bus 1002 or other communication mechanism for communicating information, and a hardware processor 1004 coupled with bus 1002 for processing information. Hardware processor 1004 may be, for example, a general-purpose microprocessor.

Computer system 1000 also includes a main memory 1006, such as a random-access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk, optical disk, or a Solid-State Drive (SSD) is provided and coupled to bus 1002 for storing information and instructions.

Computer system 1000 may be coupled via bus 1002 to a display 1012, such as a cathode ray tube (CRT), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 based on processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1010. Volatile media includes dynamic memory, such as main memory 1006. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid-state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the worldwide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

### 10. Miscellaneous; Extensions

Unless otherwise defined, all terms (including technical and scientific terms) are to be given their ordinary and customary meaning to a person of ordinary skill in the art and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

1. One or more non-transitory computer-readable media comprising instructions for training a model having an audio encoder and a language model decoder, the instructions, when executed by one or more hardware processors, cause performance of operations comprising:
receiving audio data and corresponding ground truth transcriptions;
encoding the audio data using the model to generate encoded audio features;
projecting the encoded audio features using the model to generate projected features aligned with an embedding space of the language model decoder;
processing the projected features using the model to generate model transcriptions;
calculating an alignment loss between the projected features and expected decoder input embeddings;
calculating an output loss between the model transcriptions and the corresponding ground truth transcriptions;
computing a total loss based on the alignment loss and the output loss; and
updating parameters of the model based on the total loss.

2. The one or more non-transitory computer-readable media of claim 1, wherein calculating the alignment loss comprises:
computing an L1 loss between vector representations of the projected features and the expected decoder input embeddings; and
computing a cosine similarity loss between the vector representations of the projected features and the expected decoder input embeddings.

3. The one or more non-transitory computer-readable media of claim 1, the operations further comprising:
combining the alignment loss and the output loss using a weighting parameter to generate the total loss.

4. The one or more non-transitory computer-readable media of claim 1, wherein the model comprises an adaptation layer, and wherein the adaptation layer comprises:
a first fully connected linear layer configured to transform the encoded audio features into a hidden representation having a predetermined dimension;
a ReLU activation layer configured to apply non-linear processing to the hidden representation;
a second fully connected linear layer configured to project an output of the ReLU activation layer into the embedding space of the language model decoder; and
a layer normalization layer configured to normalize an output of the second fully connected linear layer during training.

5. The one or more non-transitory computer-readable media of claim 1, wherein calculating the output loss comprises computing a cross-entropy loss between a probability distribution of the model transcriptions generated by the language model decoder and a probability distribution of the corresponding ground truth transcriptions.

6. The one or more non-transitory computer-readable media of claim 1, wherein updating parameters based on the total loss comprises:
maintaining model parameters of the audio encoder and the language model decoder as fixed values; and
updating model parameters of an adaptation layer of the model based on the total loss.

7. The one or more non-transitory computer-readable media of claim 1, the operations further comprising:
storing the projected features in a vector database;
receiving a query;
generating query embeddings from the query using the language model decoder;
retrieving relevant projected features from the vector database based on a similarity between the query embeddings and the stored projected features; and
processing the retrieved relevant projected features using the language model decoder to generate transcriptions corresponding to audio segments relevant to the query.

8. A method for training a model having an audio encoder and a language model decoder comprising:
receiving audio data and corresponding ground truth outputs;
encoding the audio data using model to generate encoded audio features;
projecting the encoded audio features through the model to generate projected features aligned with an embedding space of the language model decoder;
processing the projected features using the model to generate model outputs;
calculating an alignment loss between the projected features and expected decoder input embeddings;
calculating an output loss between the model outputs and the corresponding ground truth outputs;
computing a total loss based on the alignment loss and the output loss; and
updating parameters of the model based on the total loss.

9. The method of claim 8, wherein calculating the alignment loss comprises:
computing an L1 loss between vector representations of the projected features and the expected decoder input embeddings; and
computing a cosine similarity loss between the vector representations of the projected features and the expected decoder input embeddings.

10. The method of claim 8, further comprising:
combining the alignment loss and the output loss using a weighting parameter to generate the total loss.

11. The method of claim 8, wherein the model comprises an adaptation layer; and wherein the adaptation layer comprises:
a first fully connected linear layer configured to transform the encoded audio features into a hidden representation having a predetermined dimension;
a ReLU activation layer configured to apply non-linear processing to the hidden representation;
a second fully connected linear layer configured to project an output of the ReLU activation layer into the embedding space of the language model decoder; and
a layer normalization layer configured to normalize an output of the second fully connected linear layer during training.

12. The method of claim 8, wherein calculating the output loss comprises computing a cross-entropy loss between a probability distribution of the model outputs generated by the language model decoder and a probability distribution of the corresponding ground truth outputs.

13. The method of claim 8, wherein updating parameters based on the total loss comprises:
maintaining model parameters of the audio encoder and the language model decoder as fixed values; and
updating model parameters of an adaptation layer of the model based on the total loss.

14. The method of claim 8, further comprising:
storing the projected features in a vector database;
receiving a query;
generating query embeddings from the query using the language model decoder;
retrieving relevant projected features from the vector database based on a similarity between the query embeddings and the stored projected features; and
processing the retrieved relevant projected features using the language model decoder to generate outputs corresponding to audio segments relevant to the query.

15. A system comprising:
at least one device comprising a hardware processor; and
instructions for training a model having an audio encoder, an adaptation layer, and a language model decoder, wherein the instructions, when executed, cause the system to perform operations comprising:
receiving audio data and corresponding ground truth outputs;
encoding the audio data using the audio encoder to generate encoded audio features;
projecting the encoded audio features using the adaptation layer to generate projected features aligned with an embedding space of the language model decoder;
processing the projected features using the language model decoder to generate model outputs;
calculating an alignment loss between the projected features and expected decoder input embeddings;
calculating an output loss between the model outputs and the corresponding ground truth outputs;
computing a total loss based on the alignment loss and the output loss; and
updating parameters of the model based on the total loss.

16. The system of claim 15, wherein calculating the alignment loss comprises:
computing an L1 loss between vector representations of the projected features and the expected decoder input embeddings; and
computing a cosine similarity loss between the vector representations of the projected features and the expected decoder input embeddings.

17. The system of claim 15, the operations further comprising:
combining the alignment loss and the output loss using a weighting parameter to generate the total loss.

18. The system of claim 15, wherein the adaptation layer comprises:
a first fully connected linear layer configured to transform the encoded audio features into a hidden representation having a predetermined dimension;
a ReLU activation layer configured to apply non-linear processing to the hidden representation;
a second fully connected linear layer configured to project an output of the ReLU activation layer into the embedding space of the language model decoder; and
a layer normalization layer configured to normalize an output of the second fully connected linear layer during training.

19. The system of claim 15, wherein calculating the output loss comprises computing a cross-entropy loss between a probability distribution of the model outputs generated by the language model decoder and a probability distribution of the corresponding ground truth outputs.

20. The system of claim 15, the operations further comprising:
storing the projected features in a vector database;
receiving a query;
generating query embeddings from the query using the language model decoder;
retrieving relevant projected features from the vector database based on a similarity between the query embeddings and the stored projected features; and
processing the retrieved relevant projected features using the language model decoder to generate outputs corresponding to audio segments relevant to the query.
